(19) United States
(12) Patent Application Publication
(10) Pub. No.: US 2014/0078456 A1
(43) Pub. Date: Mar. 20, 2014

(54) Liquid Crystal Display Panel and Method for Making the Same

(71) Applicants: Peng Du, Shenzhen City (CN); Jiali Jiang, Shenzhen City (CN)

(72) Inventors: Peng Du, Shenzhen City (CN); Jiali Jiang, Shenzhen City (CN)

(73) Assignee: Shenzhen China Star Optoelectronics Technology Co. Ltd., Shenzhen, Guangdong (CN)

(21) Appl. No.: 13/642,534

(22) PCT Filed: Sep. 21, 2012
(86) PCT No.: PCT/CN2012/081747

§ 371 Date: Oct. 21, 2012

(30) Foreign Application Priority Data
Sep. 19, 2012 (CN) 201210349244.1

(51) Int. Cl. G02F 1/1339

(52) U.S. Cl. 349/153; 349/190

(57) ABSTRACT

A liquid crystal display panel is provided and which comprises first and second substrates arranged opposite to each other. Wherein the first substrate includes a pixel zone and a gluing strip arranged along perimeter of the pixel zone, the gluing strip includes thermoplastic material. Wherein the second substrate is arranged with a circuitry; and wherein the circuitry and the gluing strip is overlapped and sandwiched between the first and second substrates and the gluing strip is melted by the heat generated from the circuitry after it is energized. The present invention also provides a method for making the same. Once the circuitry is energized, the gluing strip will be cured with the heat from the circuitry. There is no need for the ultraviolet, and the curing processes are simplified, while the first and second class substrates can be readily sealed and laminated.

### FIELD OF THE INVENTION

The present invention relates to a technical field of manufacturing of liquid crystal display device, and more particularly, to a liquid crystal display panel, and a method for making the same.

### DESCRIPTION OF PRIOR ART

In recent years, the development of the liquid crystal display device has a great leap and the commercialization of the liquid crystal display panel has been widely used in all kinds of electronic devices.

During the manufacturing of the liquid crystal display panel, two glass substrates have to he sealed before the liquid crystal can be injected or fill therein. Currently, a certain type of glue is used to laminate those two glass substrates. With the glue, components and electrical circuit located between the glass substrates can be isolated from atmosphere and will not be negatively affected by humidity or being oxidized. Currently, curing of the glue is made through the ultraviolet. After the glue is exposed under the ultraviolet for a certain period of time, the glue is hardened and the glass substrates are permanently laminated.

However, using ultraviolet to cure the glue has a defect, i.e. the procedures are very complicated. Accordingly, there is a necessity to introduce a genuine liquid crystal display device, and also a method for making the same.

### SUMMARY OF THE INVENTION

It is an object of the present invention to provide a liquid crystal display panel, and also a method for making the same as the method features a simplified procedures and the lamination of two glass substrates can be readily done.

In order to resolve the technical issue encountered by the prior art, the present invention provides a technical solution by introducing a liquid crystal display panel which comprises first and second substrates arranged opposite to each other. Wherein the first substrate includes a pixel zone and a gluing strip arranged along perimeter of the pixel zone, the gluing strip includes thermoplastic material. Wherein the second substrate is arranged with a circuitry. Wherein the circuitry and the gluing strip is overlapped and sandwiched between the first and second substrates and the gluing strip is melted by the heat generated from the circuitry after it is energized. Wherein the pixel zone is an OLED pixel or a TFT-LCD pixel zone; and wherein the circuitry includes an extension going to edge of the second glass substrate and the extension is interconnected with external power.

Wherein the gluing strip is thermoplastic glue.

In order to resolve the technical issue encountered by the prior art, the present invention provides a technical solution by introducing a liquid crystal display panel which comprises first and second substrates arranged opposite to each other. Wherein the first substrate includes a pixel zone and a gluing strip arranged along perimeter of the pixel zone, the gluing strip includes thermoplastic material. Wherein the second substrate is arranged with a circuitry; and wherein the circuitry and the gluing strip is overlapped and sandwiched between the first and second substrates and the gluing strip is melted by the heat generated from the circuitry after it is energized.

Wherein the first glass substrate is as TFT glass substrate and the second glass substrate is a colorful filter substrate.

Wherein the pixel zone is an OLED pixel zone.

Wherein the pixel zone is a TFT-LCD pixel zone.

Wherein the circuitry includes art extension going to edge of the second glass substrate and the extension is interconnected with external power

In order to resolve the technical issue encountered by the prior art, the present invention provides a technical solution by introducing a method for making liquid crystal display panel, comprising the steps of: a) providing first and second glass substrates; b) deploying a gluing strip of thermoplastic material around a perimeter of a pixel zone of the first glass substrate; c) deploying a circuitry on the second glass substrate; d) marrying the first and second glass substrates such that the circuitry is overlapped with the gluing strip and both the circuitry and the gluing strip are sandwiched between the first and second glass substrates; and e) energizing the circuitry such that the gluing strip is cured by the heat generated by the circuitry.

Wherein the first glass substrate is a TFT glass substrate and the second glass substrate is a colorful filter substrate.

Wherein the pixel zone is an OLED pixel zone.

Wherein the pixel zone is a TFT-LCD pixel zone.

Wherein the circuitry includes an extension going to edge of the second glass substrate and the extension is interconnected with external power.

The present invention can be concluded with the following advantages. As compared to the existing prior art, the gluing strip having thermoplastic material is deployed around a pixel area of the first glass substrate, and the circuitry is deployed on the second glass substrate. The gluing strip is overlapped with the circuitry when the first and second glass substrates are laminated. Once the circuitry is energized, the gluing strip will be cured with the heat from the circuitry. There is no need for the ultraviolet, and the curing processes are simplified, while the first and second glass substrates can be readily sealed and laminated.

### BRIEF DRAWINGS OF PREFERRED EMBODIMENT

FIG. 1 is a flow diagram illustrating each step of making a liquid crystal display panel made in according to the present invention;

FIG. 2 is an illustrational and structural view of the liquid crystal display panel made in accordance with the present invention;

FIG. 3 is a cross sectional view taken along line A-A of FIG. 2; and

FIG. 4 is a cross sectional view taken along line B-B of FIG. 2.

### DETAILED DESCRIPTION OF PREFERRED EMBODIMENT

Detailed description in view of the preferred embodiment along, with the accompanied drawings will be given herebelow.

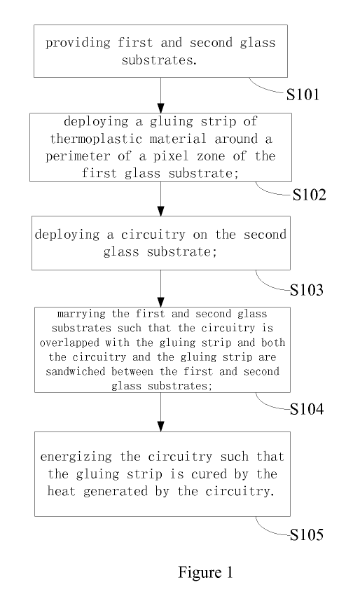

FIG. 1 is a flow diagram illustrating each step of making a liquid crystal display panel made in according to the present invention. As illustrated thereof, the manufacturing processes of the liquid crystal display device made in accordance with the present invention includes the following steps.

Step S101: providing first and second glass substrates.

Step S102: deploying a gluing strip of thermoplastic material around a perimeter of a pixel zone of the first glass substrate;

Wherein the gluing strip can be melted when it is heated and the first and second glass substrates can be laminated and sealed.

Step S103: deploying a circuitry on the second glass substrate;

Step S104: marrying the first and second glass substrates such that the circuitry is overlapped with the gluing strip and both the circuitry and the gluing strip are sandwiched between the first and second glass substrates; and

Step S105: energizing the circuitry such that the gluing strip is cured by the heat generated by the circuitry.

In the above described steps, the circuitry arranged on the second glass substrate is specially arranged so as to heat up and melt the gluing strip. Since the voltage and amperage of the circuitry is comparably larger than other circuitry of the liquid crystal display panel, accordingly, the circuitry will be arranged separately with other circuitry. Pre-measurements will be taken so as to avoid any such mixing arrangement. Furthermore, the voltage and amperage applied to the circuitry is carefully calibrated according to the property of the gluing strip.

Substantially, in the preferable embodiment, the first glass substrate is a TFT substrate, and the second glass substrate is a colorful filter glass substrate. It can be readily understood that the first glass substrate can be the colorful glass substrate, and the second glass substrate is the TFT glass substrate.

In actual applications, the circuitry can be arranged on the first or second substrates. In addition, there is a certain or pre-determined distance spared between the circuitry and other original controlling and driving circuits so as to prevent any interference or short-circuited. It is suggested that the circuitry is arranged away from the driving circuit of the pixel zone. For example, the circuitry is preferably arranged onto the colorful glass substrate.

Substantially, since there is a driving circuit on the TFT glass substrate, if the circuitry is arranged onto the TFT glass substrate, a premium distance has to be provided with respect to the pixel zone so as to avoid the short-circuit or interference or cross talk. However, this will inevitably increase the non-displaying area and this is really detrimental to the goal of narrow-boarder. On the other hand, there is no circuit arranged on the colorful glass substrate in general. As a result, accordingly, when the circuitry is arranged onto the colorful glass substrate, not only the cross talk can be avoided, the goal of narrow-boarder result can be readily achieved.

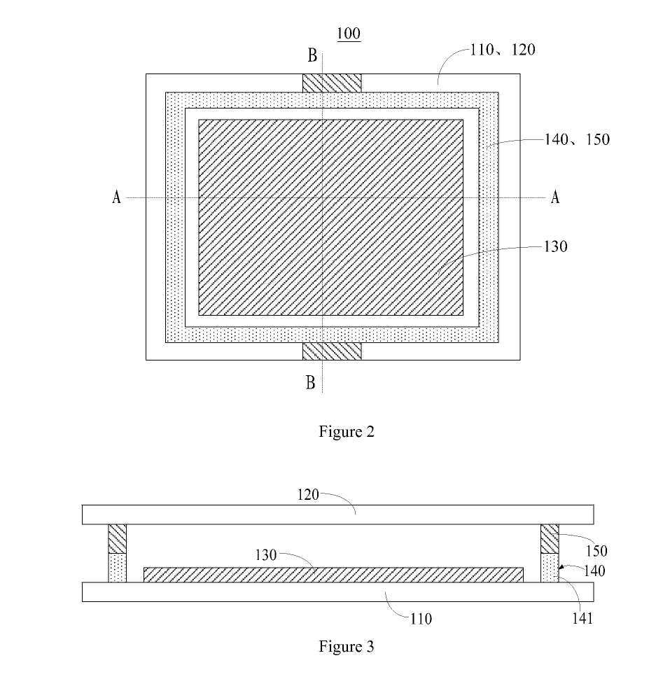

FIG. 2 is an illustrational and structural view of the liquid crystal display panel made in accordance with the present invention. FIG. 3 is a cross sectional view taken along line A-A of FIG. 2. As shown in FIGS. 7 and 3, the liquid crystal display panel 100 includes a first substrate 110, a second glass substrate 170, a pixel zone 130, a gluing strip 140, and a conductive circuitry 150.

The first glass substrate 110 and the second glass substrate 120 are arranged in opposite to each other. The first glass substrate 110 includes the pixel zone 130 and the gluing strip 140,

The second glass substrate 120 is provided with the circuitry 150 which will be overlapped with the gluing strip 140 when the first and second glass substrates 110, 120 come together. By this arrangement, the circuitry 150 is sandwiched between the first and second glass substrates 110, 120,

Furthermore, the pixel zone 130 is the TFT-LCD (thin film transistor-liquid crystal display) pixel zone, or the OLED (organic light-emitting diode) pixel zone.

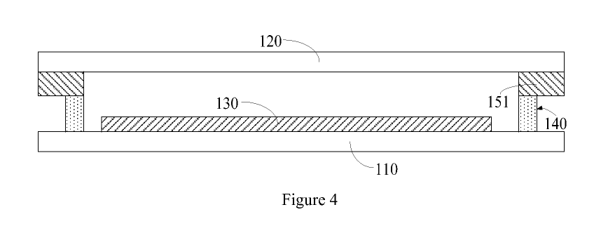

Referring to FIG. 4 which is a cross sectional view taken along line B-B of FIG. 2. The circuitry 150 includes an extension 151 reaching to an edge of the second glass substrate 120 for interconnection with an external power source to energize the circuitry 150. Both the circuitry 150 and its extension 151 are made from conductive material.

The present invention can be concluded with the following advantages. As compared to the existing prior art, the gluing strip having thermoplastic material is deployed around a pixel area of the first glass substrate, and the circuitry is deployed on the second glass substrate. The gluing strip is overlapped with the circuitry when the first and second glass substrates are laminated. Once the circuitry is energized, the gluing strip will be cured with the heat from the circuitry. There is no need for the ultraviolet, and the curing processes are simplified, while the first and second glass substrates can be readily sealed and laminated.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

1. A liquid crystal display panel, comprising:
first and second substrates arranged opposite to each other;
wherein the first substrate includes a pixel zone and a gluing strip arranged along perimeter of the pixel zone, the gluing strip includes thermoplastic material;
wherein the second substrate is arranged with a circuitry;
wherein the circuitry and the gluing strip is overlapped and sandwiched between the first and second substrates and the gluing strip is melted by the heat generated from the circuitry after it is energized;
wherein the pixel zone is an OLED pixel or a TFT-LCD pixel zone; and
wherein the circuitry includes an extension going to edge of the second glass substrate and the extension is interconnected with external power.

2. The liquid crystal display panel as recited in claim 1, wherein the gluing strip is thermoplastic glue.

3. A liquid crystal display panel, comprising:
first and second substrates arranged opposite to each other;
wherein the first substrate includes a pixel zone and a gluing strip arranged along perimeter of the pixel zone, the gluing strip includes thermoplastic material;
wherein the second substrate is arranged with a circuitry; and
wherein the circuitry and the gluing strip is overlapped and sandwiched between the first and second substrates and the gluing strip is melted by the heat generated from the circuitry after it is energized.

4. The liquid crystal display panel as recited in claim 3, wherein the first glass substrate is a TFT glass substrate and the second glass substrate is a colorful filter substrate.

5. The liquid crystal display panel as recited in claim 3, wherein the pixel zone is an OLED pixel zone.

6. The liquid crystal display panel as recited in claim 3, wherein the pixel zone is a TFT-LCD pixel zone.

7. The liquid crystal display panel as recited in claim 3, wherein the circuitry includes an extension going to edge of the second glass substrate and the extension is interconnected with external power.

8. A method for making liquid crystal display panel, comprising the steps of:
a) providing first and second glass substrates;
b) deploying a gluing strip of thermoplastic material around a perimeter of a pixel zone of the first glass substrate;
c) deploying a circuitry on the second glass substrate;
d) marrying the first and second glass substrates such that the circuitry is overlapped with the gluing strip and both the circuitry and the gluing strip are sandwiched between the first and second glass substrates; and
e) energizing the circuitry such that the gluing strip is cured by the heat generated by the circuitry.

9. The method as recited in claim 8, wherein the first glass substrate is a TFT glass substrate and the second glass substrate is a colorful filter substrate.

10. The method as recited in claim 8, wherein the pixel zone is an OLED pixel zone.

11. The method as recited in claim 8, wherein the pixel zone is a TFT-LCD pixel zone.

12. The method as recited in claim 8, wherein the circuitry includes an extension going to edge of the second glass substrate and the extension is interconnected with external power.
